(19) United States
(12) Patent Application Publication
(10) Pub. No.: US 2025/0316257 A1
(43) Pub. Date: Oct. 9, 2025

(54) APPARATUS AND METHOD FOR CANCELLING VEHICLE NOISES

(71) Applicant: HANWHA AEROSPACE CO., LTD., Changwon-si (KR)

(72) Inventors: Tae Kwang YOO, Changwon-si (KR); Jin Ho YOON, Changwon-si (KR)

(73) Assignee: HANWHA AEROSPACE CO., LTD., Changwon-si (KR)

(21) Appl. No.: 18/819,368

(22) Filed: Aug. 29, 2024

(30) Foreign Application Priority Data
Apr. 8, 2024 (KR) 10-2024-0047366

(51) Int. Cl. G10K 11/178

(52) U.S. Cl. CPC G10K 11/1785; G10K 11/17857; G10K 11/17873

(57) ABSTRACT

A vehicle noise cancelling apparatus including: at least one microphone provided on a vehicle and configured to detect a noise generated from one or more noise sources; at least one antiphase speaker configured to generate an antiphase sound wave; one or more processors; and one or more memories storing program instructions, where, by executing the program instructions, the one or more processors are configured to: obtain the detected noise from the at least one microphone, measure parameters based on an environment in which the vehicle is being driven, determine a radiation pattern of the noise based on the detected noise and the measured parameters, produce a sound wave in antiphase to the detected noise based on the radiation pattern of the noise, and control the at least one antiphase speaker to generate the antiphase sound wave.

This application is based on and claims priority to Korean Patent Application No. 10-2024-0047366, filed on Apr. 8, 2024, in the Korean Intellectual Property Office, the disclosure of which is incorporated herein in its entirety by reference.

### BACKGROUND

### 1. Field

The present disclosure relates to noise cancelling technology, and more particularly, to a technology that cancels out noise generated from a plurality of noise sources of a vehicle being driven in various environments.

### 2. Description of the Related Art

In a weapon system, ground vehicles such as tanks, armored vehicles, self-propelled artillery and battle vehicles and aerial vehicles such as helicopters and drones which generate lift necessary for flight using rotating blades may be likely to be discovered by an enemy's weapon system due to various noises generated while they are moving, and thus their fighting power may be likely to be exposed. The biggest noises in the weapon system are, in the case of the ground vehicles, engine exhaust noise, friction noise of tracks themselves, friction noise between the tracks and a vehicle body, friction noise between tracks/wheels and a road surface, etc. and, in the case of the aerial vehicles, are motor noise, friction noise between rotating blades and the air, etc. Therefore, it is essential to reduce these noises.

A conventional active noise cancellation (ANC) apparatus for cancelling out the above noises may immediately detect a signal at a time when noise occurs and generate a waveform opposite to the noise, thereby eliminating the noise in a mutually cancelling manner. The ANC has been used to eliminate noise introduced into a vehicle in order to protect passengers inside the vehicle (to protect hearing, maintain an environment in which communication is possible, etc.).

However, in the case of battle vehicles, it may be necessary to reduce (or cancel) noise radiated to the outside in order to minimize detection during maneuver or combat for tactical deployment. In addition, for effective/three-dimensional noise reduction, the location of a noise source and the direction and pattern of noise spread may need to be considered together.

### SUMMARY

Provided is an adaptive active noise canceller (ANC) technique which prevents a movable vehicle from being detected from the outside by effectively cancelling/reducing noises generated in the vehicle for various reasons.

Additional aspects will be set forth in part in the description which follows and, in part, will be apparent from the description, or may be learned by practice of the presented embodiments.

According to an aspect of the disclosure, a vehicle noise cancelling apparatus may include: at least one microphone provided on a vehicle and configured to detect a noise generated from one or more noise sources; at least one antiphase speaker configured to generate an antiphase sound wave; one or more processors; and one or more memories storing program instructions, wherein, by executing the program instructions, the one or more processors are configured to: obtain the detected noise from the at least one microphone, measure parameters based on an environment in which the vehicle is being driven, determine a radiation pattern of the noise based on the detected noise and the measured parameters, produce a sound wave in antiphase to the detected noise based on the radiation pattern of the noise, and control the at least one antiphase speaker to generate the antiphase sound wave.

The at least one microphone and the at least one antiphase speaker may be provided adjacent to the one or more noise sources.

The one or more processors may be further configured to: based on a position of the at least one antiphase speaker, control the at least one antiphase speaker to generate an antiphase sound wave having directivity toward the one or more noise sources.

The one or more noise sources may include at least one of a driving wheel of a ground vehicle or a propeller of an aerial vehicle.

The one or more processors may be configured to control the at least one antiphase speaker to generate the antiphase sound wave having directivity by controlling a sound field of the at least one antiphase speaker.

The at least one antiphase speaker may be arranged as an array speaker.

The one or more processors may be further configured to store a parameter model in a database, where the parameter model is generated by learning the measured parameters in advance.

The one or more processors may be further configured to determine the radiation pattern of the noise by comparing the measured parameters with the generated parameter model.

The one or more processors are further configured to update the database based on the measured parameters being different from the parameter model stored in the database by at least a predetermined threshold.

The one or more processors may be further configured to: measure atmospheric conditions including at least one of atmospheric pressure, temperature, and humidity; and determine a type of a road surface on which the vehicle is being driven through at least one of a vision sensor and the at least one microphone.

The type of the road surface may include at least two of asphalt road surface, concrete road surface, sand road surface, gravel road surface, and natural ground.

The one or more processors may be further configured to measure a driving speed of the vehicle.

The driving speed may be measured from at least one of a GPS sensor and a wheel encoder provided on the vehicle.

The one or more processors may be further configured to: measure atmospheric conditions based on the vehicle being at a standstill after being started, and measure the driving speed while the vehicle is being driven.

The one or more processors may be further configured to determine whether the detected noise is at least one of a dynamic noise which is based on a movement of the vehicle or a static noise which is independent of the movement of the vehicle.

The one or more processors may be further configured to: based on the detected noise being the dynamic noise, correct a pitch of the produced antiphase sound wave according to a speed at which the vehicle moves from a location at which the noise is generated.

The one or more processors may be further configured to change an amount by which the pitch is corrected according to a change in speed at which the vehicle moves from the location at which the noise is generated, where the pitch after the correction corresponds to the pitch before the correction and the amount of correction.

The one or more processors are further configured to: based on a position of the at least one antiphase speaker, control the at least one antiphase speaker to generate at least one of an antiphase sound wave having directivity toward the one or more noise sources and an omnidirectional antiphase sound wave.

According to an aspect of the disclosure, a vehicle noise cancelling method performed by an apparatus which includes a processor and a memory storing program instructions to be executed by the processor, the method including: detecting a noise generated from one or more noise sources with at least one microphone provided on a vehicle; measuring parameters based on an environment in which the vehicle is being driven; determining a radiation pattern of the noise based on the detected noise and the measured parameters; producing a sound wave in antiphase to the detected noise based on the radiation pattern of the noise; and generating the produced antiphase sound wave through at least one antiphase speaker, where the at least one microphone and the at least one antiphase speaker are provided adjacent to the one or more noise sources.

The generating the produced antiphase sound wave may include generating, based on a position of the at least one antiphase speaker, an antiphase sound wave having directivity toward a noise source.

The method may further include: storing a parameter model in a database, the parameter model being generated by leaning the measured parameters in advance.

According to an aspect of the disclosure, non-transitory computer-readable medium having instructions stored therein, which when executed by one or more processors cause the one or more processors to execute a vehicle noise cancelling method including: obtaining a detected noise from at least one microphone provided on a vehicle; obtaining measuring parameters based on an environment in which the vehicle is being driven; determining a radiation pattern of the noise based on the detected noise and the measured parameters; producing a sound wave in antiphase to the detected noise based on the radiation pattern; and generating the produced antiphase sound wave through at least one antiphase speaker.

The vehicle control method may further include: storing a parameter model in a database, where the parameter model is generated by learning the measured parameters in advance; and determining the radiation pattern by comparing the measured parameters with the generated parameter model.

The vehicle noise cancelling method may further include: updating the database based on the measured parameters being different from the parameter model stored in the database by at least a predetermined threshold.

### BRIEF DESCRIPTION OF DRAWINGS

These and other aspects, features, and advantages of certain embodiments will become apparent and more readily appreciated from the following description of the embodiments, taken in conjunction with the accompanying drawings in which:

FIG. 1 is a block diagram of a vehicle noise cancelling apparatus according to an embodiment of the present disclosure;

FIG. 2 illustrates a process in which noise and an antiphase sound wave overlap and cancel each other out according to an embodiment of the disclosure;

FIG. 3 is a detailed block diagram of a parameter measurer included in the vehicle noise cancelling apparatus according to an embodiment of the disclosure;

FIG. 4A illustrates an example of forming an omnidirectional antiphase sound wave;

FIG. 4B illustrates an example of forming an antiphase sound wave having directivity through beamforming;

FIG. 5A illustrates various noise sources of a ground vehicle;

FIG. 5B illustrates various noise sources of an aerial vehicle;

FIG. 6 illustrates a form in which sound waves of noise generated while a friendly vehicle is being driven are transmitted to an enemy vehicle;

FIG. 7 is a block diagram of an artificial intelligence (AI) device in accordance with an exemplary embodiment of the present disclosure;

FIG. 8 is an example of a deep neural network (DNN) model to which the present disclosure may be applied; and

FIG. 9 is a block diagram illustrating the hardware configuration of a computing device that implements a vehicle noise cancelling apparatus in FIG. 1.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Terms used herein are for illustrating the embodiments rather than limiting the present disclosure.

It will be understood that the terms “includes,” “comprises,” “has,” “having,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

Hereinafter, exemplary embodiments of the present disclosure will be described in detail with reference to the accompanying drawings.

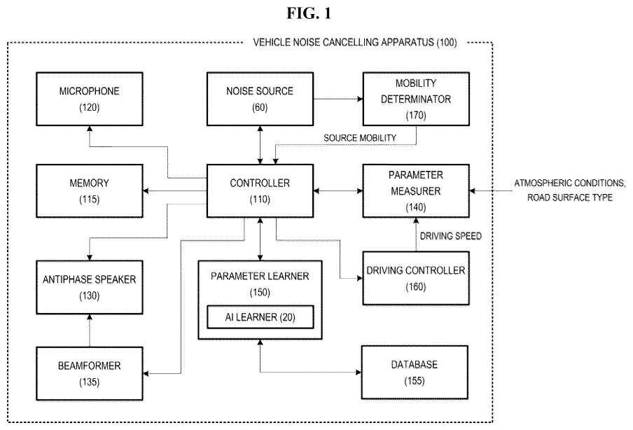

FIG. 1 is a block diagram of a vehicle noise cancelling apparatus 100 according to an embodiment of the present disclosure.

The vehicle noise cancelling apparatus 100 may be installed in a vehicle with a noise source 60, which generates noise from inside the vehicle itself or through interaction with the outside, and has a function of cancelling out the noise. The noise source 60 may include noise located inside the vehicle. However, the noise source 60 is not required to be located inside the vehicle, and noise may also be generated when a part of the vehicle comes into contact with the external environment. Examples of the vehicle include ground vehicles with wheels and tracks and aerial vehicles with propellers and wings. The vehicle noise cancelling apparatus 100 may include a controller 110, which is also referred to as a processor (e.g., one or more processors), a microcontrol unit (MCU) or an electronic control unit (ECU), and a memory 115 which stores program instructions to be executed by the controller 110. The controller (e.g., the processor) according to embodiments of the present disclosure may include one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory.

The vehicle noise cancelling apparatus 100 may further include a microphone 120, the noise source 60, an antiphase speaker 130, a beamformer 135, a parameter measurer 140, a parameter learning unit 150, a database 155, a driving controller 160, and a mobility determination unit 170, in addition to the controller 110 and the memory 115.

The microphone 120 may detect noise generated from a plurality of noise sources 60 mounted on the vehicle. In addition, the parameter measurer 140 may have a function of measuring parameters which affect the noise while the vehicle is being operated.

Here, the controller 110 may predict a radiation pattern of the noise based on the detected noise and the measured parameters, and produce a sound wave in antiphase to the generated noise based on the predicted radiation pattern of the noise.

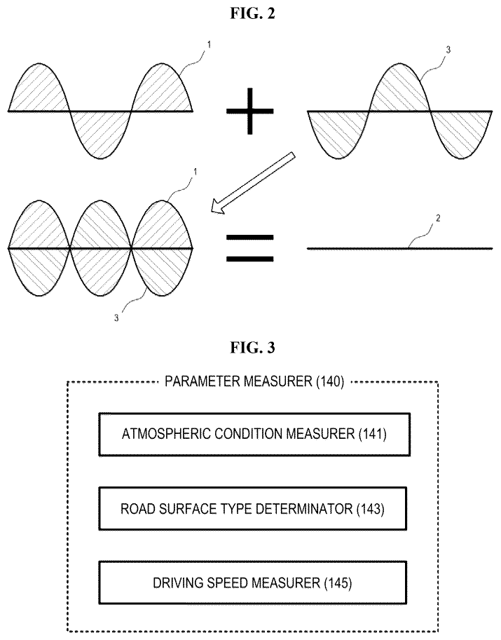

The antiphase speaker 130 may modulate the produced sound wave and radiate the modulated sound wave to the outside under the control of the controller 110. FIG. 2 illustrates a process in which noise and an antiphase sound wave overlap and cancel each other out.

First, when a sound wave 3 in complete antiphase to noise 1 generated from a noise source 60 is radiated by the antiphase speaker 130, the two may overlap, and their opposite waveforms may cancel each other out. As a result, the noise 1 may be eliminated as indicated by reference numeral 2. This process is called active noise cancelling (ANC) and is a distinct concept from passive noise cancelling (PNC) which simply blocks noise independent of the characteristics of the noise.

In addition, general ANC may be used for the purpose of protecting the hearing of passengers inside equipment and for smooth communication. According to an embodiment, ANC may be used for preventing a vehicle with various types of noise sources (noise sources with various waveforms, frequencies, and amplitudes) from being detected/discovered. This ANC will hereinafter be referred to as adaptive ANC. Various mobility equipment such as tanks, armored vehicles, self-propelled artillery and battle vehicles and aircraft with rotating blades such as helicopters and drones are bound to generate considerable noise during operation, and this noise may be cancelled by applying the adaptive ANC.

In order to provide the adaptive ANC function, a combination of the microphone 120 and the antiphase speaker 130 corresponding to each of the noise sources 60 mounted on a vehicle may be installed adjacent to each of the noise sources 60. That is, a microphone and an antiphase speaker may be installed near each noise source to cancel out individual noise generated from the noise source. However, depending on a noise source, there may be cases where a microphone and an antiphase speaker cannot be installed near the noise source. A solution to this problem will be described later.

Parameters measured by the parameter measurer 140 may be learned in advance by the parameter learner 150. To this end, the parameter learner 150 may learn the parameters in advance based on a radiation pattern of noise, build a model (parameter model) for the parameters, and store the model in the database 155. This learning may be based on supervised or unsupervised artificial intelligence (AI) learning. However, the present disclosure is not limited thereto, and other known learning algorithms (optimization algorithms, functional relational models, etc.) may also be used. In the present disclosure, a case where parameter learning is based on AI learning and thus the parameter learner 150 includes an AI learner 20 will be described as an example.

Main sources of noise generated from a vehicle may include noise generated from rotors such as an engine, a ventilation fan and a cooling fan, noise generated when tracks collide with the ground, and noise generated due to the vibration of a vehicle body. A database of this noise distribution may be built in advance through measurement and interpretation and may be used later in real time to reproduce antiphase noise. In addition, since the noise distribution data may vary according to driving speed and road surface/atmospheric conditions, it is a database may be built accordingly.

Therefore, if various physical quantities can be measured using sensors such as a LiDAR sensor, a camera, a temperature sensor, a humidity sensor, a pressure sensor and a microphone, an environment in which the database 155 storing various parameter models can be built and utilized in real time is created. In addition, when conditions of existing measured parameters fall outside a predetermined threshold, the database 155 may be updated to further improve the accuracy of noise cancellation. This will be described in detail later with reference to FIG. 3.

Ultimately, the controller 110 may predict the radiation pattern of the noise by comparing the measured parameters with the generated parameter model. ANC itself may provide a function of cancelling out noise measured in real time by generating an antiphase waveform to the noise using an antiphase speaker. However, since a processing process for such measurement and waveform generation requires a certain amount of time, unexpected temporary noise (or transition noise) may be radiated to the outside without being cancelled during the noise cancellation process. This temporary noise may reveal the presence and location of a vehicle.

Therefore, according to an embodiment, noise cancellation may be performed in a manner suitable for the characteristics of a specific noise source and its environment by predicting a radiation pattern of noise based on parameters. Accordingly, the generation of temporary noise can be minimized.

FIG. 3 is a detailed block diagram of the parameter measurer 140 included in the vehicle noise cancelling apparatus 100.

As illustrated, the parameter measurer 140 may include an atmospheric condition measurer 140 and a road surface type determinator 143 and may further include a driving speed measurer 145.

The atmospheric condition measurer 141 measures atmospheric conditions including at least one of atmospheric pressure, temperature, and humidity. Antiphase sound waves produced vary according to atmospheric conditions such as temperature, humidity and pressure. Therefore, the atmospheric conditions may be taken into consideration in order to learn and determine more accurate and rapid noise radiation pattern data.

The road surface type determinator 143 may determine the type of a road surface on which a vehicle is being driven through a vision sensor such as a LiDAR sensor, a laser or a visible light camera or a microphone that can obtain driving sounds. The type of the road surface may include at least two of asphalt road surface, concrete road surface, sand road surface, gravel road surface, and rough/wild ground (e.g., natural ground). In general, radiation pattern data of noise radiated from ground vehicles and aerial vehicles may have predictable characteristics under certain conditions. Therefore, an antiphase waveform can be produced and learned in advance based on pre-obtained noise radiation pattern data for each noise generation location (e.g. track, wheel, cooling fan, ventilation fan, exhaust port, etc.) and for each road surface type (asphalt, cement, sand, gravel, soil, etc.).

The driving speed measurer 145 may measure the driving speed of the vehicle and produce a driving speed parameter. The driving speed may be measured from the driving controller 160 (see FIG. 1) having a GPS sensor and/or a wheel encoder mounted on the vehicle. Antiphase sound waves for the measured atmospheric conditions and for a noise source for each road condition (e.g., road surface type) can be enhanced for a semi-active noise cancellation by additionally considering the driving speed (e.g., vehicle moving speed, engine RPM, rotation speed of rotating blades, etc.).

Here, the atmospheric condition measurer 141 may measure and learn the atmospheric conditions before the vehicle is driven because the atmospheric conditions can be secured even when the vehicle is at a standstill after being started. On the other hand, the road surface type determined by the road surface type determinator 143 and the driving speed measured by the driving speed measurer 145 are parameters that may be obtained during actual driving of the vehicle.

Referring to FIG. 1, as described above, a combination of the microphone 120 and the antiphase speaker 130 may be installed near each noise source 60 to cancel out individual noise generated from the noise source 60. However, depending on the noise source 60, there may be cases in which the microphone 120 and the antiphase speaker 130 cannot be installed near the noise source 60. For example, wheels or tracks (caterpillars) of ground vehicles and rotating blades and propellers of aerial vehicles are noise sources that generate large noise. However, since these parts may move at high speeds with respect to the vehicle body, it may be difficult to install other fixed parts near them. Therefore, in this case, the antiphase speaker 130 may be installed at a location distant from such a noise source and may generate sound waves having directivity toward the noise source, thereby achieving a noise cancelling effect.

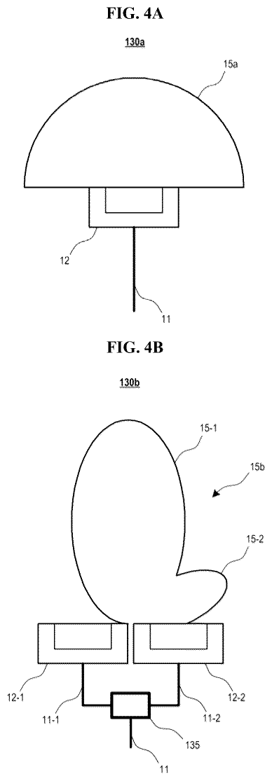

FIG. 4A illustrates an example of forming an omnidirectional antiphase sound wave. FIG. 4B illustrates an example of forming an antiphase sound wave having directivity through beamforming.

According to an embodiment of the present disclosure, when the microphone 120 and the antiphase speaker 130 are installed near a corresponding noise source, a typical antiphase speaker 130a that forms an omnidirectional antiphase sound wave 15a as illustrated in FIG. 4A may be used. The antiphase speaker 130a may include a signal input line 11 and an amplifier 12 which generates the omnidirectional antiphase sound wave 15a according to a signal input through the signal input line 11.

According to an embodiment of the present disclosure, when the microphone 120 and the antiphase speaker 130 cannot be installed near a corresponding noise source, an antiphase speaker 130b that forms an antiphase sound wave 15b having directivity as illustrated in FIG. 4B may be used. The antiphase speaker 130b may include a signal input line 11, branch lines 11-1 and 11-2 which branch from the signal input line 11 and are input to individual amplifiers 12-1 and 12-2, and a plurality of individual amplifiers 12-1 and 12-2 which finally radiate the antiphase sound wave 15b. Here, a beamformer 135 may be installed between the signal input line 11 and the branch lines 11-1 and 11-2. The beamformer 135 may form a beamforming shape by controlling a sound field of the antiphase speaker 130b based on a signal input from the signal input line 11, so that the antiphase sound wave 15b can have directivity. By applying such beamforming, the individual amplifiers 12-1 and 12-2 may create a specific sound field pattern by adding a processing signal to a wave equation.

The sound wave 15b in the beamforming shape may be created by the overlap of individual sound field patterns 15-1 and 15-2 radiated by the individual amplifiers 12-1 and 12-2, respectively. The beamforming shape may be formed by a plurality of individual amplifiers 12-1 and 12-2. However, the present disclosure is not limited thereto, and the beamforming shape may also be formed by a single amplifier.

According to an embodiment of the present disclosure, since a plurality of microphones 120 and antiphase speakers 130 are already provided at each noise location in a vehicle, they may be used together as an array speaker. In this case, the antiphase speakers 130 provided at different noise locations may be combined, and an antiphase sound wave in a three-dimensional (3D) beamforming shape may be generated by the beamformer 135. Therefore, it is possible to three-dimensionally reduce noise generated from a noise source 60 disposed at a location at which it may be difficult to install an antiphase speaker. In this way, when a greater number of antiphase speakers are combined, a sound field pattern of a complex shape may be created, and sound pressure may be concentrated on a noise source. Therefore, more effective noise cancellation may result.

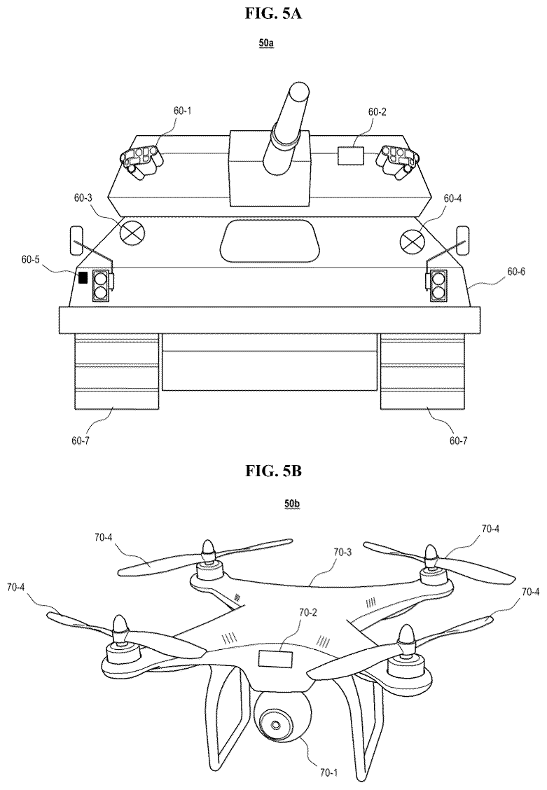

FIG. 5A illustrates various noise sources 60-1 through 60-7 of a ground vehicle 50a. FIG. 5B illustrates various noise sources 70-1 through 70-4 of an aerial vehicle 50b.

Referring to FIG. 5A, the noise sources 60-1 through 60-7 of the ground vehicle 15a may include a vision sensor 60-1 such as a LiDAR sensor or a camera, an environment sensor 60-2 which measures pressure, temperature, humidity, etc., a cooling fan 60-3 for cooling heat generating parts, a ventilation fan 60-4 for blowing air, an exhaust port 60-5 for discharging internal air to the outside, a vehicle body structure 60-6 which generates noise according to the natural frequency of the vehicle itself, and driving units 60-7 such as wheels and tracks for driving the vehicle.

In addition, referring to FIG. 5B, the noise sources 70-1 through 70-4 of the aerial vehicle 15b may include a vision sensor 70-1 such as a LiDAR sensor or a camera, an environmental sensor 70-2 which measures pressure, temperature, humidity, etc., a vehicle body structure 70-3 which generates noise according to the natural frequency of the vehicle itself, and propelling units 70-4 such as rotating blades and propellers for moving the vehicle and providing lift.

Various noise sources may have different locations and noise radiation patterns, and actual noise radiated to the outside appears as the overlap of individual noises generated from these various noise sources. Therefore, a combination of the microphone 120 and the antiphase speaker 130 corresponding to each of these various noise sources 60 may be installed near each of the noise sources 60 to maximize noise cancelling performance. In addition, when the microphone 120 and the antiphase speaker 130 cannot be installed near a noise source 60 such as a driving unit 60-7 (e.g., a wheel, a track, etc.) or a propelling units 70-4 (e.g., a rotating blade, a propeller, etc.), the microphone 120 or the antiphase speaker 130 may be inevitably installed at a location distant from the noise source 60. However, the above-described beamformer 135 may control the antiphase speaker 130 such that an antiphase sound wave has directivity toward the noise source 60, thereby preventing degradation of the noise cancelling performance.

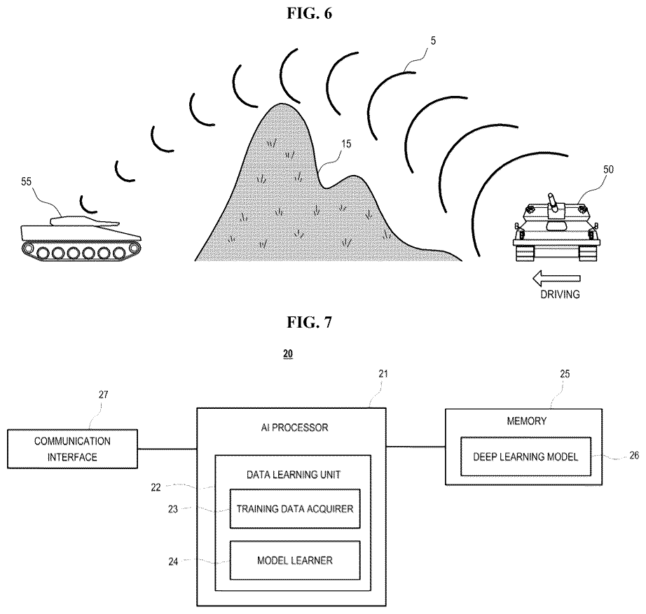

FIG. 6 illustrates a form in which sound waves 5 of noise generated while a friendly vehicle 50 is being driven are transmitted to an enemy vehicle 55. Referring to FIG. 6, the noise 5 generated from the friendly vehicle 50 being driven may be transmitted to the enemy vehicle 55 directly or over an obstacle 15. Therefore, the enemy vehicle 55 may identify the presence and location of the friendly vehicle 50 by detecting the type, size, and direction of the noise 5.

In this case, if the friendly vehicle 50 cancels the noise 5 through active ANC, the noise 5 can be eliminated or reduced and thus prevented from being detected by the enemy vehicle 55.

However, if the friendly vehicle 50 is being driven, a Doppler effect occurs in the noise generated. Therefore, the Doppler effect needs to be additionally taken into consideration. To this end, the mobility determinator 170 determines whether the noise generated while a vehicle is being driven is dynamic noise which moves with the vehicle or static noise which is unrelated to the movement of the vehicle.

Since all of the noise sources illustrated in FIGS. 5A and 5B are noises that move with the vehicle, there may be no need to consider the Doppler effect. For example, when the friendly vehicle 50 illustrated in FIG. 5A moves, the above noises may also move with the vehicle. Therefore, if the noises are generated, the Doppler effect may occur in the noises heard by the enemy vehicle 55. However, if the noises are cancelled by the friendly vehicle 50 itself, no noise may be heard by the enemy vehicle 55 despite the Doppler effect. Therefore, there may be no problem.

However, if the noises are static noises generated by interaction between the moving vehicle 50 and the external environment (e.g., the ground colliding with the wheels or tracks of the vehicle, wind noise caused by the movement of the vehicle, etc.), the Doppler effect must be taken into consideration because the antiphase speaker 130 for cancelling out the static noises is moving.

Therefore, when the generated noise is static noise, the controller 110 may correct a pitch of the produced antiphase sound wave according to the speed at which the vehicle moves away from a location where the noise is generated. The controller 110 may increase the amount by which the pitch is corrected as the speed at which the vehicle moves away increases, and the pitch after the correction may be higher than the pitch before the correction by the amount of correction. This is because when the antiphase sound wave radiated through the directional antiphase speaker 130 in the vehicle being driven is directed toward the static noise, since the directional antiphase speaker 130 and the static noise are receding from each other, proper noise cancellation may be achieved only when the pitch of the antiphase sound wave radiated from the vehicle is that high.

For static noise, there may be no need to consider the location or moving speed of the enemy vehicle 55 which is a listener. This is because when there is a noise, the noise may be heard after its pitch is changed according to the moving speed of a listener, but if noise cancellation has already been effectively achieved, listening itself may not occur regardless of the pitch change.

Correcting the pitch of static noise in consideration of the Doppler effect as described above may be performed according to Equation 1 below.

$${f}_{C} = \frac{v}{v - {v}_{S}} \times {f}_{S} , \qquad ( 1 )$$

where f_{C} is a pitch (frequency) after correction, v is a standard speed of sound, v_{S} is a moving speed of the friendly vehicle 50, and f_{S} is an original pitch (frequency) of a sound wave generated from a source.

In addition, the controller 110 may update the database 155 when the measured parameters are different from the parameter model stored in the database 155 by more than a reference value. In some examples, this may be a process of updating the database 155 when parameters showing significant differences are found through comparison/analysis between parameters obtained by measuring actual ambient noise and a learned parameter model.

FIG. 7 is a block diagram of an artificial intelligence (AI) device in accordance with an exemplary embodiment of the present disclosure.

An AI learner 20 may include a communication device including an AI module capable of performing AI processing, a server including the AI module, or the like. The AI learner 20 may include an AI processor 21, a memory 25 and/or a communication interface 27. The AI learner 20 is a computing device capable of learning a neural network, and may be implemented as various electronic devices such as a server, a desktop PC, a notebook PC, and a tablet PC.

The AI processor 21 may learn a neural network by using a program stored in the memory 25. In particular, the AI processor 21 may learn a neural network for recognizing noise radiation-related data. Here, the neural network for recognizing noise radiation-related data may be designed to simulate a human brain structure on a computer, and may include a plurality of network nodes with weights that simulate neurons of the human neural network. The plurality of network nodes may exchange data according to their respective connection relationships such that neurons may simulate the synaptic activity of neurons for sending and receiving signals through synapses. Here, the neural network may include a deep learning model developed from a neural network model. In the deep learning model, a plurality of network nodes may be located in different layers and exchange data according to a convolutional connection relationship. Examples of neural network models include various deep learning techniques, such as deep neural networks (DNN), convolutional deep neural networks (CNN), recurrent neural networks (RNN), restricted Boltzmann machine (RBM), deep belief networks (DBN), or Deep Q-Networks, and may be applied to fields such as computer vision, speech recognition, natural language processing, and speech/signal processing.

The AI processor 21 according to embodiments of the present disclosure may include one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory.

The memory 25 may store various programs and data for the operation of the AI learner 20. The memory 25 may be implemented by a non-volatile memory, a volatile memory, a flash memory, a hard disk drive (HDD), a solid state drive (SDD), or the like. The memory 25 is accessed by the AI processor 21, and data read/write/edit/delete/update by the AI processor 21 may be performed. In addition, the memory 25 may store a neural network model (e.g., a deep learning model 26) generated through a learning algorithm for data classification/recognition in accordance with an exemplary embodiment of the present disclosure.

The AI processor 21 may include a data learning unit 22 for learning a neural network for data classification/recognition. The data learning unit 22 may learn a criterion on which training data to use and how to classify and recognize data using the training data in order to determine data classification/recognition. The data learning unit 22 may learn the deep learning model by acquiring training data to be used for learning and applying the acquired training data to the deep learning model.

The data learning unit 22 may be manufactured in the form of at least one hardware chip and mounted on the AI learner 20. For example, the data learning unit 22 may be manufactured in the form of a dedicated hardware chip for artificial intelligence (AI), or may be manufactured as a part of a general-purpose processor (CPU) or a dedicated graphics processor (GPU) and mounted on the AI learner 20. In addition, the data learner 22 may be implemented as a software module. When implemented as a software module (or a program module including an instruction), the software module may be stored in a non-transitory computer-readable medium. In this case, at least one software module may be provided by an operating system (OS) or an application.

The data learner 22 may include a training data acquirer 23 and a model learner 24.

The training data acquisition unit 23 may acquire training data requested for the neural network model for classifying and recognizing data. For example, the training data acquisition unit 23 may acquire noise radiation data and/or sample data for input into the neural network model as training data.

The model learner 24 may learn to have a criterion for determining how the neural network model classifies predetermined data by using the acquired training data. In this case, the model learner 24 may train the neural network model through supervised learning using at least a portion of the training data as a criterion for determination. Alternatively, the model learner 24 may train the neural network model through unsupervised learning to discover a criterion by self-learning using the training data without being supervised. In addition, the model learner 24 may train the neural network model through reinforcement learning by using feedback on whether the result of situation determination based on the learning is correct. In addition, the model learner 24 may train the neural network model by using a learning algorithm including an error back-propagation method or a gradient decent method.

When the neural network model is trained, the model learning unit 24 may store the learned neural network model in the memory. The model learner 24 may store the learned neural network model in a memory of a server connected to the AI learner 20 via a wired or wireless network.

The data learner 22 may further include a training data preprocessor and a training data selector in order to improve the analysis result of the recognition model or to save resources or time required for generating the recognition model.

The training data preprocessor may preprocess the acquired data such that the acquired data may be used for learning to determine the situation. For example, the training data preprocessor may process the acquired data into a preset format such that the model learning unit 24 may use the training data acquired for learning for image recognition.

In addition, the training data selection unit may select data required for training from the training data acquired by the training data acquirer 23 or the training data preprocessed by the preprocessor. The selected training data may be provided to the model learner 24. For example, the training data selection unit may select only data on an object included in a specific region as the training data by detecting the specific region among images acquired through a camera.

In addition, the data learner 22 may further include a model evaluation unit to improve the analysis result of the neural network model.

The model evaluation unit may input evaluation data to the neural network model, and may cause the model learner 24 to retrain the neural network model when an analysis result output from the evaluation data does not satisfy a predetermined criterion. In this case, the evaluation data may be predefined data for evaluating the recognition model. For example, the model evaluation unit may evaluate the model as not satisfying a predetermined criterion when, among the analysis results of the trained recognition model for the evaluation data, the number or ratio of evaluation data for which the analysis result is inaccurate exceeds a preset threshold. The communication interface 27 may transmit the AI processing result by the AI processor 21 to an external communication device.

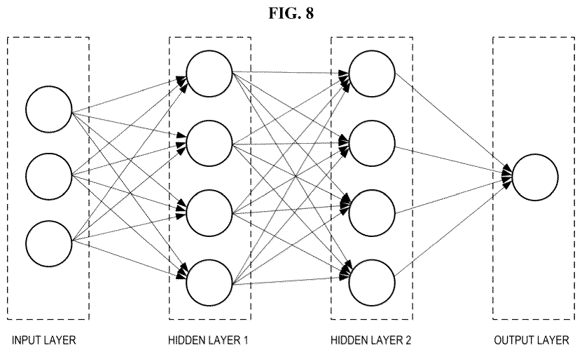

FIG. 8 is an example of a deep neural network (DNN) model to which the present disclosure may be applied.

The deep neural network (DNN) is an artificial neural network (ANN) including several hidden layers between an input layer and an output layer. The deep neural network may model complex non-linear relationships, as in typical artificial neural networks.

For example, in a deep neural network structure for an object identification model, each object may be represented as a hierarchical configuration of basic image elements. In this case, the additional layers may aggregate the characteristics of the gradually gathered lower layers. This feature of deep neural networks allows more complex data to be modeled with fewer units (nodes) than similarly performed artificial neural networks.

As the number of hidden layers increases, the artificial neural network is called ‘deep’, and machine learning paradigm that uses such a sufficiently deepened artificial neural network as a learning model is called deep learning. Furthermore, the sufficiently deep artificial neural network used for the deep learning is commonly referred to as the deep neural network (DNN).

In the present disclosure, data to train the generated parameter model may be input to the input layer of the DNN, and meaningful evaluation data that may be used by a user may be generated through the output layer while the data pass through the hidden layers. In this way, the accuracy of the evaluation data trained through the neural network model can be represented by a probability, and the higher the probability, the higher the accuracy of the evaluated result.

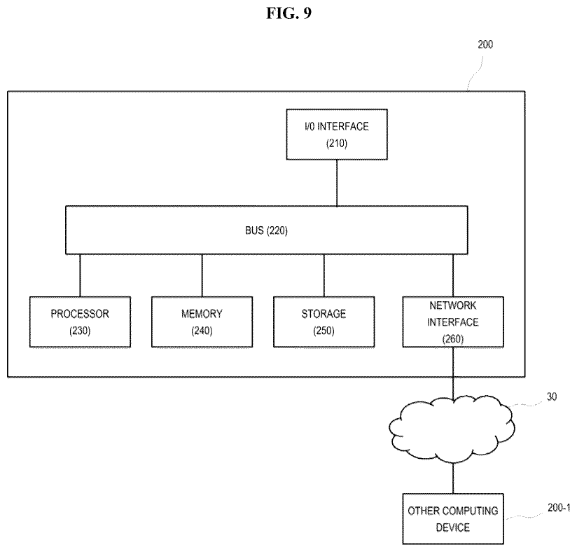

FIG. 9 is a block diagram illustrating the hardware configuration of a computing device 200 that implements a vehicle noise cancelling apparatus 100 in FIG. 1.

The computing device 200 may include a bus 220, a processor 230, a memory 240, a storage 250, an input/output interface 210, and a network interface 260. The bus 220 is a path for the transmission of data between the processor 230, the memory 240, the storage 250, the input/output interface 210, and the network interface 260. However, it is not limited how the processor 230, the memory 240, the storage 250, the input/output interface 210, and the network interface 260 are connected. The processor 230 may include one or more processors, which may be implemented as an arithmetic processing unit such as a central processing unit (CPU) or a graphics processing unit (GPU). The memory 240 may include one or more memories, which may be implemented as a random-access memory (RAM) or a read-only memory (ROM). The storage 250 may include one or more a storage devices such as a hard disk, a solid state drive (SSD), or a memory card. The storage 250 may also be a memory such as a RAM or a ROM.

The input/output interface 210 may be an interface for connecting the computing device 200 and an input/output device. For example, a keyboard or a mouse may be connected to the input/output interface 210.

The network interface 260 may be an interface for communicatively connecting the computing device 200 and an external device to exchange transport packets with each other. The network interface 260 may be a network interface for connection to a wired line or for connection to a wireless line. For example, the computing device 200 may be connected to another computing device 200-1 via a network 30.

The storage 250 may store program modules that implement the functions of the computing device 200. The processor 230 may implement the functions of the computing device 200 by executing the program modules. Here, the processor 230 may read the program modules into the memory 240 and may then execute the program modules.

The hardware configuration of the computing device 200 is not limited to the configuration illustrated in FIG. 9. For example, the program modules may be stored in the memory 240. In this example, the computing device 200 may not include the storage 250.

The vehicle noise cancelling apparatus 100 may at least include the processor 230 and the memory 240, which stores instructions that can be executed by the processor 230. The vehicle noise cancelling apparatus 100 of FIG. 1 may be driven by executing instructions including a variety of functional blocks or steps included in the vehicle noise cancelling apparatus 100, via the processor 230.

A vehicle noise cancelling apparatus and method according to the present disclosure enables tactical deployment through covert maneuver of battle vehicles without being detected by an enemy.

In addition, even when applied to aircraft (such as drones) equipped with rotating blades or general civilian wheeled vehicles, the apparatus and method can effectively reduce noise that adversely affects the surrounding environment.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. A vehicle noise cancelling apparatus comprising:
at least one microphone provided on a vehicle and configured to detect a noise generated from one or more noise sources;
at least one antiphase speaker configured to generate an antiphase sound wave;
one or more processors; and
one or more memories storing program instructions,
wherein, by executing the program instructions, the one or more processors are configured to:
obtain the detected noise from the at least one microphone,
measure parameters based on an environment in which the vehicle is being driven,
determine a radiation pattern of the noise based on the detected noise and the measured parameters,
produce a sound wave in antiphase to the detected noise based on the radiation pattern of the noise, and
control the at least one antiphase speaker to generate the antiphase sound wave.

2. The apparatus of claim 1, wherein the at least one microphone and the at least one antiphase speaker are provided adjacent to the one or more noise sources.

3. (canceled)

4. The apparatus of claim 3, wherein the one or more noise sources include at least one of a driving wheel of a ground vehicle and a propeller of an aerial vehicle.

5. The apparatus of claim 4, wherein the one or more processors are configured to control the at least one antiphase speaker to generate the antiphase sound wave having directivity by controlling a sound field of the at least one antiphase speaker.

6. The apparatus of claim 5, wherein the at least one antiphase speaker is arranged as an array speaker.

7. The apparatus of claim 1, wherein the one or more processors are further configured to store a parameter model in a database, and
wherein the parameter model is generated by learning the measured parameters in advance.

8. The apparatus of claim 7, wherein the one or more processors are further configured to determine the radiation pattern of the noise by comparing the measured parameters with the generated parameter model.

9. (canceled)

10. The apparatus of claim 1, wherein the one or more processors are further configured to:
measure atmospheric conditions comprising at least one of atmospheric pressure, temperature, and humidity; and
determine a type of a road surface on which the vehicle is being driven through at least one of a vision sensor and the at least one microphone.

11. The apparatus of claim 10, wherein the type of the road surface comprises at least two of asphalt road surface, concrete road surface, sand road surface, gravel road surface, and natural ground.

12. The apparatus of claim 10, wherein the one or more processors are further configured to measure a driving speed of the vehicle.

13. (canceled)

14. The apparatus of claim 12, wherein the one or more processors are further configured to:
measure atmospheric conditions based on the vehicle being at a standstill after being started, and
measure the driving speed while the vehicle is being driven.

15. The apparatus of claim 1, whether the detected noise is at least one of a dynamic noise which is based on a movement of the vehicle and a static noise which is independent of the movement of the vehicle.

16. The apparatus of claim 15, wherein the one or more processors are further configured to:
based on the detected noise being the dynamic noise, correct a pitch of the produced antiphase sound wave according to a speed at which the vehicle moves from a location at which the noise is generated.

17. The apparatus of claim 16, wherein the one or more processors are further configured to change an amount by which the pitch is corrected according to a change in speed at which the vehicle moves from the location at which the noise is generated, and
wherein the pitch after the correction corresponds to the pitch before the correction and the amount of correction.

18. A vehicle noise cancelling method performed by an apparatus which comprises a processor and a memory storing program instructions to be executed by the processor, the method comprising:
detecting a noise generated from one or more noise sources with at least one microphone provided on a vehicle;
measuring parameters based on an environment in which the vehicle is being driven;
determining a radiation pattern of the noise based on the detected noise and the measured parameters;
producing a sound wave in antiphase to the detected noise based on the radiation pattern of the noise; and
generating the produced antiphase sound wave through at least one antiphase speaker,
wherein the at least one microphone and the at least one antiphase speaker are provided adjacent to the one or more noise sources.

19. (canceled)

20. The method of claim 18, further comprising storing a parameter model in a database, the parameter model being generated by leaning the measured parameters in advance.

21. The apparatus of claim 2, wherein the one or more processors are further configured to:
based on a position of the at least one antiphase speaker, control the at least one antiphase speaker to generate at least one of an antiphase sound wave having directivity toward the one or more noise sources and an omnidirectional antiphase sound wave.

22. A non-transitory computer-readable medium having instructions stored therein, which when executed by one or more processors cause the one or more processors to execute a vehicle noise cancelling method comprising:
obtaining a detected noise from at least one microphone provided on a vehicle;
obtaining measuring parameters based on an environment in which the vehicle is being driven;
determining a radiation pattern of the noise based on the detected noise and the measured parameters;
producing a sound wave in antiphase to the detected noise based on the radiation pattern; and
generating the produced antiphase sound wave through at least one antiphase speaker.

23. The non-transitory computer-readable medium of claim 22, wherein the vehicle noise cancelling method further comprises:
storing a parameter model in a database,
wherein the parameter model is generated by learning the measured parameters in advance; and
determining the radiation pattern by comparing the measured parameters with the generated parameter model.

24. The non-transitory computer-readable medium of claim 23, wherein the vehicle noise cancelling method further comprises:
updating the database based on the measured parameters being different from the parameter model stored in the database by at least a predetermined threshold.
